(19) United States
(12) Patent Application Publication
(10) Pub. No.: US 2009/0280306 A1
(43) Pub. Date: Nov. 12, 2009

(54) HOUSING AND METHOD FOR MAKING THE SAME

(75) Inventors: CHE-YUAN HSU, Shindian (TW); FU-KENG YANG, Shindian (TW); CHENG-WEN SU, Shindian (TW); YI-QIANG XU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (Hong Kong) LIMITED, Kowloon (HK)

(21) Appl. No.: 12/432,892

(22) Filed: Apr. 30, 2009

(30) Foreign Application Priority Data
May 9, 2008 (CN) 200810301520.0

(51) Int. Cl. B32B 3/10; B32B 38/00

(52) U.S. Cl. 428/201; 156/245

(57) ABSTRACT

A housing includes a substrate, a decorative layer attached to the substrate, a first transparent plastic film covering the decorative layer, a second transparent plastic film attached to the first transparent plastic film, and a flexible paint layer coated on the second transparent plastic film.

### CROSS-REFERENCE TO RELATED APPLICATIONS

This application is related to a co-pending U.S. patent application (Attorney Docket No. US20142), entitled “HOUSING AND METHOD FOR MAKING THE SAME”. Both applications have the same assignee and were concurrently filed

### BACKGROUND

1. Technical Field

The present invention relates to housings for mobile device and, particularly, to a housing for mobile devices with soft surface.

2. Description of Related Art

Mobile devices, such as mobile telephones, personal digital assistants, or MP3 players, enable consumers to enjoy the convenience of high technology services, anytime and at virtually any location. These mobile devices often employ a variety of decorative housings to attract consumers. Paint and ink are typically applied onto housing surfaces to provide the necessary decorative appearance. Nowadays, housings, which appear attractive not only to the eye but also to the touch, such as soft housings, are highly desirable. In a typical process for making the soft housing, a soft material is employed to cover the housing, to form a soft layer on the housing. The soft material is typically a flexible resin.

However, flexible resins poorly adhere to the housings and are liable to be worn out over time.

Therefore, there is room for improvement within the art.

### BRIEF DESCRIPTION OF THE DRAWINGS

Many aspects of the housing can be better understood with reference to the following drawings. The components in the drawings are not necessarily to scale, the emphasis instead being placed upon clearly illustrating the principles of the present housing. Moreover, in the drawings, like reference numerals designate corresponding parts throughout the following view.

FIG. 1 is a cut-away view of an exemplary embodiment of the present housing.

FIG. 2 is a flow chart of an exemplary embodiment of a method for making the housing shown in FIG. 1.

FIG. 3 is a cut-away view of an exemplary embodiment of two rollers during making the housing shown in FIG. 1.

### DETAILED DESCRIPTION

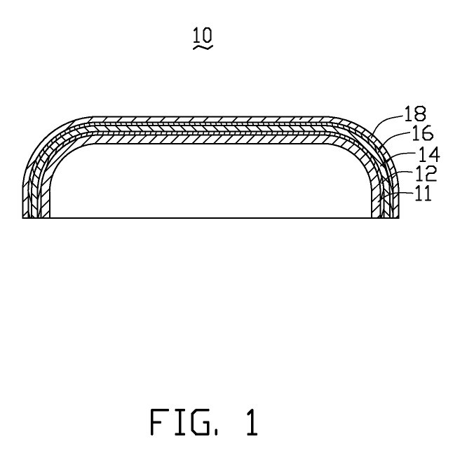

Referring to FIG. 1, a housing 10 of a present exemplary embodiment includes a substrate 11, a decorative layer 12 attached to the substrate 11, a first transparent plastic film 14 covering the decorative layer 12, a second transparent plastic film 16 attached to the first transparent plastic film 14, and a flexible paint layer 18 coated on the second transparent plastic film 16.

The substrate 11 may be made of plastic selected from a group consisting of polyethylene, polycarbonate, acrylonitrile butadiene styrene, poly methyl methacrylate, and poly ethylene terephthalate.

The decorative layer 12 is an ink coating formed by screen printing and. may define a pattern.

The first transparent plastic film 14 is made of clear plastic selected from a group consisting of polycarbonate, poly ethylene terephthalate, poly methyl methacrylate, and poly lactic acid. The first transparent plastic film 14 may be firstly coated with the decorative layer 12. Ultimately, the decorative layer 12 is attached to the substrate 11. That is, the decorative layer 12 is sandwiched between the substrate 11 and the first transparent plastic film 14.

The second transparent plastic film 16 is made of one of polypropylene and polyamide. The second transparent plastic film 16 covers and is attached to the first transparent plastic film 14.

The flexible paint layer 18 is made of poly urethane varnish, which is coated on the second transparent plastic film 16 by spray painting on an opposite surface to the first transparent plastic film 14.

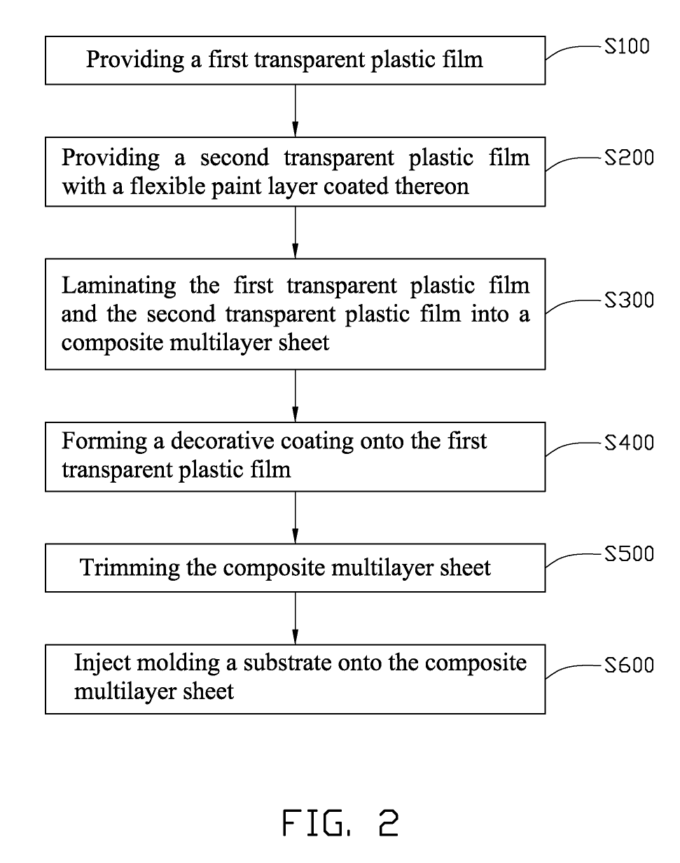

Referring to FIG. 2, a method of an exemplary embodiment for making the housing 10 may include the following steps S100 to S600.

In step S100, the first transparent plastic film 14 is provided.

In step S200, the second transparent plastic film 16 is provided. The second transparent plastic film 16 is coated with the flexible paint layer 18 by spray painting.

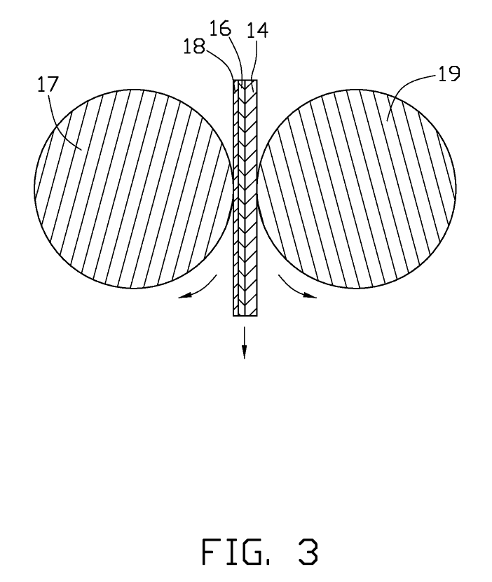

In step S300, referring to FIG. 3, the first transparent plastic film 14 and the second transparent plastic film 16 are laminated together by using two rollers 17 and 19 to form a composite multilayer sheet. The rollers 17 and 19 rotate in opposite directions. In an exemplary embodiment, the roller 17 is clockwise rotated, with the roller 19 being counterclockwise rotated. The rollers 17 and 19 define a gap therebetween. The width of the gap is slightly smaller than an aggregate thickness of the first transparent plastic film 14, the second transparent plastic film 16, and the flexible paint layer 18. The first transparent plastic film 14 and the second transparent plastic film 16 with the flexible paint layer 18 then pass through the gap and are pressed by the rollers 17 and 19 so that the first transparent plastic film 14 and the second transparent plastic film 16 are laminated into a composite multilayer sheet. The lamination by the rollers 17 and 19 may flatten out the flexible paint layer 18.

In step S400, the decorative coating 12 is screen printed, using ink, on the surface of the first transparent plastic film 14 opposite to the second transparent plastic film 16.

In step S500, the composite multilayer sheet is trimmed into a desired shape.

In step S600, the trimmed composite multilayer sheet is placed into an injection mold. A melted plastic selected from a group consisting of polyethylene, polycarbonate, acrylonitrile butadiene styrene, poly methyl methacrylate, and poly ethylene terephthalate is then injected onto the first transparent plastic film 14, thereby forming the substrate 11, with the decorative layer 12 being sandwiched between the substrate 11 and the first transparent plastic film 14.

What is claimed is:

1. A housing, comprising:
a substrate;
a decorative layer attached to the substrate;
a first transparent plastic film covering the decorative layer;
a second transparent plastic film attached to the first transparent plastic film; and
a flexible paint layer coated on a surface of the second transparent plastic film opposite to the first transparent plastic film.

2. The housing as claimed in claim 1, wherein the substrate is made of plastic selected from a group consisting of polyethylene, polycarbonate, acrylonitrile butadiene styrene, poly methyl methacrylate, and poly ethylene terephthalate.

3. The housing as claimed in claim 1, wherein the decorative layer is an ink coating.

4. The housing as claimed in claim 1, wherein the first transparent plastic film is made of clear plastic selected from a group consisting of polycarbonate, poly ethylene terephthalate, poly methyl methacrylate, and poly lactic acid.

5. The housing as claimed in claim 1, wherein the second transparent plastic film is made of one of polypropylene and polyamide.

6. The housing as claimed in claim 1, wherein the flexible paint layer is made of poly urethane varnish.

7. A method for making a housing, comprising:
providing a first transparent plastic film;
providing a second transparent plastic film with a flexible paint layer coated thereon;
laminating the first transparent plastic film and the second transparent plastic film into a composite multilayer sheet;
forming a decorative coating onto the first transparent plastic film; and
injection molding a substrate onto the composite multilayer sheet, with the decorative layer sandwiched between the substrate and the first transparent plastic film.

8. The method as claimed in claim 7, wherein the substrate is made of plastic selected from a group consisting of polyethylene, polycarbonate, acrylonitrile butadiene styrene, poly methyl methacrylate, and poly ethylene terephthalate.

9. The method as claimed in claim 7, wherein the decorative layer is formed by screen printing.

10. The method as claimed in claim 7, wherein the first transparent plastic film is made of clear plastic selected from a group consisting of polycarbonate, poly ethylene terephthalate, poly methyl methacrylate, and poly lactic acid.

11. The method as claimed in claim 7, wherein the second transparent plastic film is made of one of polypropylene and polyamide.

12. The method as claimed in claim 7, wherein the flexible paint layer is made of poly urethane varnish and formed by spray painting.
